(19) United States
(12) Patent Application Publication
(10) Pub. No.: US 2019/0165467 A1
(43) Pub. Date: May 30, 2019

(54) MULTI-ANTENNA SYSTEM USING NON-RADIATION COUPLING EDGES TO ACHIEVE ISOLATION

(71) Applicant: METAL INDUSTRIES RESEARCH & DEVELOPMENT CENTRE, Kaohsiung City (TW)

(72) Inventors: Yuan-Chih LIN, Yunlin County (TW); Jheng-Hong SHIH, Kaohsiung City (TW); Zong-Yi YANG, Yilan County (TW)

(73) Assignee: METAL INDUSTRIES RESEARCH & DEVELOPMENT CENTRE, Kaohsiung City (TW)

(21) Appl. No.: 16/166,498

(22) Filed: Oct. 22, 2018

(30) Foreign Application Priority Data
Nov. 30, 2017 (TW) 106141903

(51) Int. Cl. H01Q 1/52; H01Q 21/24; H01Q 13/12; H01Q 5/35

(52) U.S. Cl. CPC H01Q 1/523; H01Q 5/35; H01Q 13/12; H01Q 21/245

(57) ABSTRACT

A multi-antenna system uses non-radiation coupling edges to achieve isolation. A first radiation antenna, a second radiation antenna and at least one isolator are disposed on the surface of a substrate, wherein each of the first radiation antenna and the second radiation has a resonance radiating portion, a feeding portion, and at least one non-radiation coupling edge. The isolator is disposed between the first and second radiating antennas, extending from the non-radiation coupling edge of the first radiating antenna to that of the second radiating antenna. By disposing the isolator beside the non-radiation coupling edges, the near field coupling energy between the first and second radiating antennas is cancelled out, thereby improving the isolation of the antenna. By changing the length of the isolator, the resonant frequency of the system can be adjusted.

### BACKGROUND OF THE INVENTION

### 1. Field of the Invention

The invention relates to an antenna system with high isolation, in particular to a multi-antenna system for antenna isolation using non-radiation coupling edges.

### 2. Description of Related Art

With the development of wireless communication technology, the demand for high data transmission has also increased. To meet such a huge amount of data transmission, wireless communication devices utilize the multi-input multi-output (MIMO) antenna system to achieve wireless data transmission. In the MIMO antenna system, a large number of antenna elements are used, each of which has its own transmission frequency band, so that the antenna elements can transmit data at the same time, achieving multi-frequency transmission. Good isolation is required among the antenna elements to avoid mutual interference.

If there is sufficient space in the wireless communication device for a plurality of antenna elements, then an appropriate distance can be kept between adjacent antenna elements to reduce interference. However, the development of wireless communication devices, such as mobile communication handheld devices, is mainly oriented toward the miniaturization of their volumes. Therefore, the space of wireless communication devices is limited. If the isolation between antenna elements is not good, interference will happen and affect the transmission quality.

In addition to increasing the spatial distance between adjacent antenna elements to improve isolation, another method is to provide an isolator between the antenna elements. However, the isolator is currently disposed near the signal radiation edge of each antenna element. Although the isolation effect is improved, the isolator affects the characteristics of the antenna element due to the coupling with the antenna element. For example, the radiation field pattern can be changed. What is even worse is that the design parameters of the antenna system are entirely changed and cannot meet the communication requirements. Therefore, it is more important to realize a high isolation antenna system within a smaller, limited space.

### SUMMARY OF THE INVENTION

An objective of the invention is to provide a multi-antenna system that utilizes non-radiation coupling edges to achieve isolation, so that the isolation between antenna elements can be improved within a limited space while maintaining characteristics of the antenna elements.

To achieve the above-mentioned objective, the multi-antenna system includes a substrate, on which is provided with:

a first radiation antenna having a first resonance radiating portion, a first feeding portion, and a first non-radiation coupling edge, with the first feeding portion employed to feed signals to the first radiation antenna;

a second radiation antenna having a second resonance radiating portion, a second feeding portion, and a second non-radiation coupling edge, with the second feeding portion employed to feed signals to the first radiation antenna, wherein the second radiation antenna and the first radiation antenna work independently at nearby frequencies; and

at least one first isolator disposed between the first radiation antenna and the second radiation antenna and extending from the first non-radiation coupling edge toward the second non-radiation coupling edge, thereby forming a mechanism for independent coupling and resonant matching.

According to the invention, the at least one first isolator is disposed between the two radiation antennas to increase isolation. The isolator is close to the non-radiation coupling edges of the radiation elements. Therefore, the existing radiation field pattern of the radiation antennas is not interfered. Moreover, the distance between the isolator and the radiation antennas do not need to be limited to a specific length. By changing the length of the isolator, the resonance frequency of the antennas can be modified.

### BRIEF DESCRIPTION OF THE DRAWINGS

FIG. 1 is a planar view of a first embodiment of the disclosed multi-antenna system;

FIG. 2 is a planar view of a second embodiment of the disclosed multi-antenna system;

FIG. 3 is a planar view of a third embodiment of the disclosed multi-antenna system;

FIG. 4 is a perspective view of the third embodiment in FIG. 3;

FIG. 5 is a planar view of a fourth embodiment of the disclosed multi-antenna system;

FIG. 6 is a perspective view of the fourth embodiment in FIG. 5;

FIG. 7 shows the characteristic curve of the S parameter by comparing the fourth embodiment and the antenna system without an isolator;

FIG. 8 shows the characteristic curves of the S₁₁, S₁₂, S₂₂ parameters by comparing the third embodiment and the fourth embodiment;

FIGS. 9A and 9B are respectively the radiation field patterns on the XZ plane and the YZ plane according to the third embodiment;

FIGS. 10A and 10B are respectively the radiation field patterns on the XZ plane and the YZ plane according to the fourth embodiment; and

FIG. 11 is a planar view of a fifth embodiment of the disclosed multi-antenna system.

### DETAILED DESCRIPTION OF THE PREFERRED EMBODIMENT

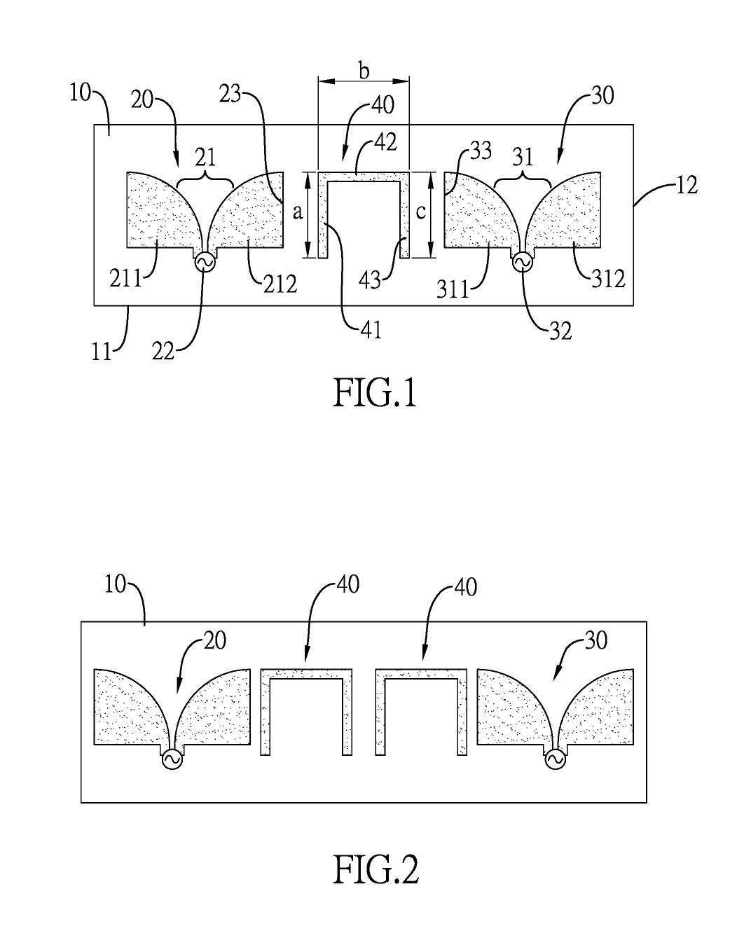

FIG. 1 shows a first embodiment of the multi-antenna system that utilizes non-radiation coupling edges to achieve isolation according to the invention. A substrate 10 is provided with a first radiation antenna 20, a second radiation antenna 30, and at least one first isolator 40. The first radiation antenna 20 and the second radiation antenna 30 have nearby frequencies.

The substrate 10 is made of an insulating material, such as polyimide (PI), to make it flexible. For the convenience of explanation, the substrate 10 is a rectangular substrate with a first edge 11 and a second edge 12. The first edge 11 and the second edge 12 are perpendicularly connected, extending along a first direction and a second direction, respectively.

The first radiation antenna 20 is made of a conductive material (e.g., a metal material) and formed on the surface of the substrate 10. The first radiation antenna 20 has a first resonance radiating portion 21, a first feeding portion 22, and a first non-radiation coupling edge 23. The first radiation antenna 20 in this embodiment is implemented by a highly oriented Vivaldi antenna. The first resonance radiating portion 21 has two sector radiating elements 211, 212 disposed in a symmetric way. Each of the sector radiating elements 211, 212 has an arc edge, a bottom edge, and a side edge. The arc edges of the sector radiating elements 211, 212 are opposite to each other to form a conic groove. The bottom edges and the side edges of the sector radiating elements 211, 212 do not have or have only a weak radiation effect. The bottom edges are parallel to the first edge 11, and the side edges are parallel to the second edge 12. The first feeding portion 22 is disposed at the bottom edge to feed signals to the first radiation antenna 20. The first non-radiation coupling edge 23 is the side edge of one sector radiating element 212.

The second radiation antenna 30 has a second resonance radiating portion 31, a second feeding portion 32, and a second non-radiation coupling edge 33. The second radiation antenna 30 in this embodiment has the same structure as the first radiation antenna 20. The second resonance radiating portion 31 also includes two sector radiating elements 311, 312. The second feeding portion 32 feeds signals to the second radiation antenna 30. The second non-radiation coupling edge 33 is the side edge of one sector radiating element 311.

The first isolator 40 is disposed between the first radiation antenna 20 and the second radiation antenna 30. The first isolator 40 has an inverted-U structure with a first metal strip 41, a second metal strip 42 and a third metal strip 43. The first metal strip 41 of the first isolator 40 is in close proximity to but not connected to the first non-radiation coupling edge 23 of the first radiation antenna 20. The first metal strip 41 extends along the direction parallel to the second edge 12. The second metal strip 42 extends horizontally from the upper end of the first metal strip 41, parallel to the first edge 11. The third metal strip 43 extends downward from one end of the second metal strip 42, parallel to the second edge 12. The third metal strip 43 is in close proximity to but not connected to the second non-radiation coupling edge 33 of the second radiation antenna 30.

The electromagnetic coupling effects between the first isolator 40 and the first radiation antenna 20 and the second radiation antenna 30 can eliminate the original near field coupling path of the first radiation antenna 20 and the second radiation antenna 30, i.e. achieving the decoupling effect, thereby improving isolation. More explicitly, through electromagnetic capacitor coupling, the first non-radiation coupling edge 23 of the first radiation antenna 20, the first metal strip 41, the second metal strip 42 and the third metal strip 43 form a filter resonance mode, thereby providing a good isolation between the first radiation antenna 20 and the second radiation antenna 30. The first isolator 40 has the above-mentioned filter resonance effect for either of the first radiation antenna 20 and the second radiation antenna 30. For the first radiation antenna 20, a filter resonance mode is formed from the first metal strip 41 near the first radiation antenna 20, the first non-radiation coupling edge 23, the second metal strip 42 and the third metal strip 43 via electromagnetic capacitor coupling. For the second radiation antenna 30, a filter resonance mode is formed from the third metal strip 43, the second non-radiation coupling edge 33, the second metal strip 42, and the first metal strip 41 via electromagnetic capacitor coupling. The length of the first metal strip 41 is a, the length of the second metal strip 42 is b, and the length of the third metal strip 43 is c. By adjusting the total length a+b+c of the first isolator 40, the resonance frequency of the antenna system can be changed. In one embodiment, the lengths a, b, and c are all equal. In another embodiment, the lengths are all different, a≠b≠c.

Please refer to FIG. 2 for a second embodiment of the invention. In comparison with the first embodiment in FIG. 1, multiple first isolators 40 are disposed between the first radiation antenna 20 and the second radiation antenna 30 to achieve multi-level isolation to further improve the isolating effect. This embodiment uses two isolators 40 as an example. The two isolators 40 are separated from each other without any connection.

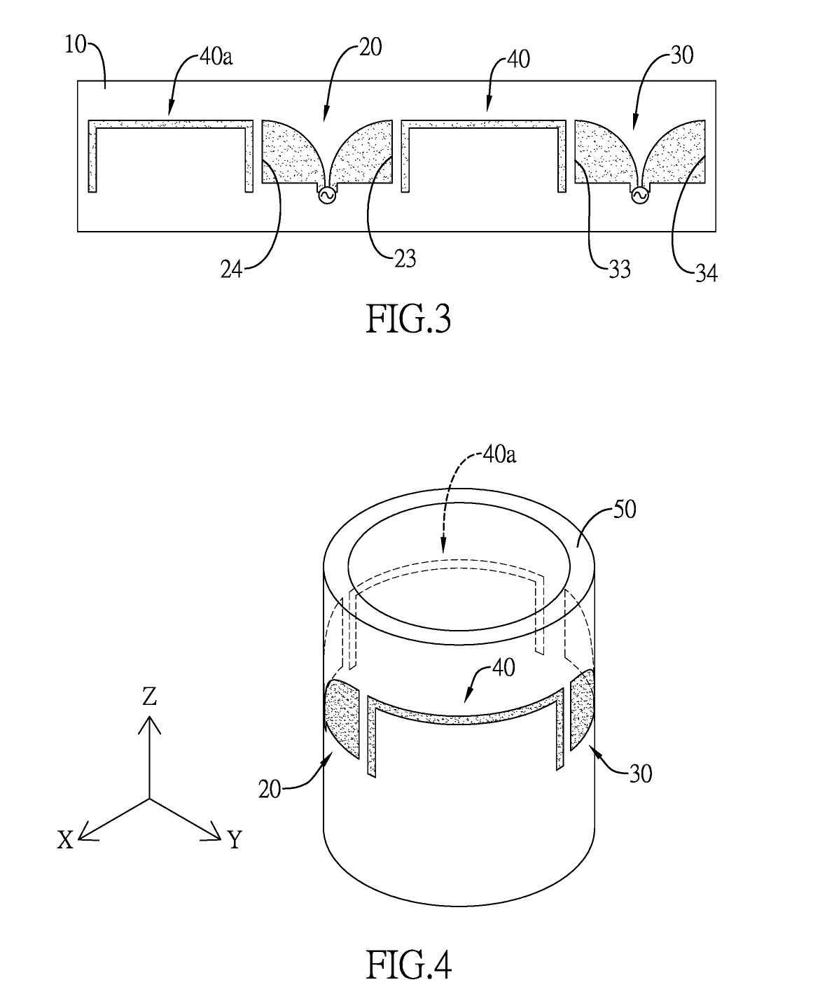

In the first and second embodiments, the substrate 10 has a planar configuration. If the substrate 10 is made of a flexible material, it can be curled or bent into other shapes. Please refer to FIGS. 3 and 4 for a third embodiment of the invention. The substrate 10 is curled into a cylindrical shape and around an outer surface of a cylindrical substrate 50. The cylindrical substrate 50 can be made of polyethylene or some other insulating material.

In comparison with the first embodiment, the embodiment in FIGS. 3 and 4 further includes at least one second isolator 40a. This is because after the substrate 10 is curled into a cylindrical shape, one side of the first radiation antenna 20 and one side of the second radiation antenna 30 are in close proximity. Therefore, the second isolator 40a is required to be placed between the first radiation antenna 20 and the second radiation antenna 30. The straight edge of the sector radiating element 211 of the first radiation antenna 20 functions as a third non-radiation coupling edge 24. The straight edge of the sector radiating element 312 of the second radiation antenna 30 functions as a fourth non-radiation coupling edge 34. The second isolator 40a is disposed between the third non-radiation coupling edge 24 and the fourth non-radiation coupling edge 34.

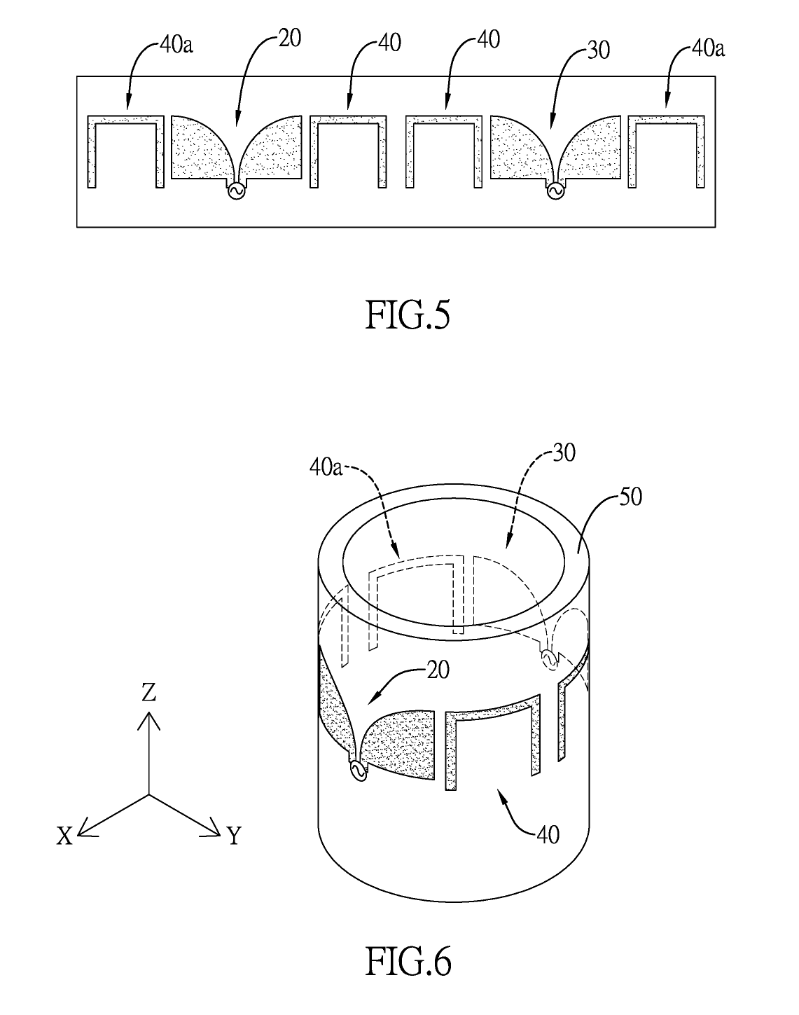

Please refer to a fourth embodiment shown in FIGS. 5 and 6. Analogously, multiple second isolators 40a can be disposed between the third non-radiation coupling edge 24 and the fourth non-radiation coupling edge 34 to achieve multi-level isolation, so that the cylindrical antenna system has a better isolating effect.

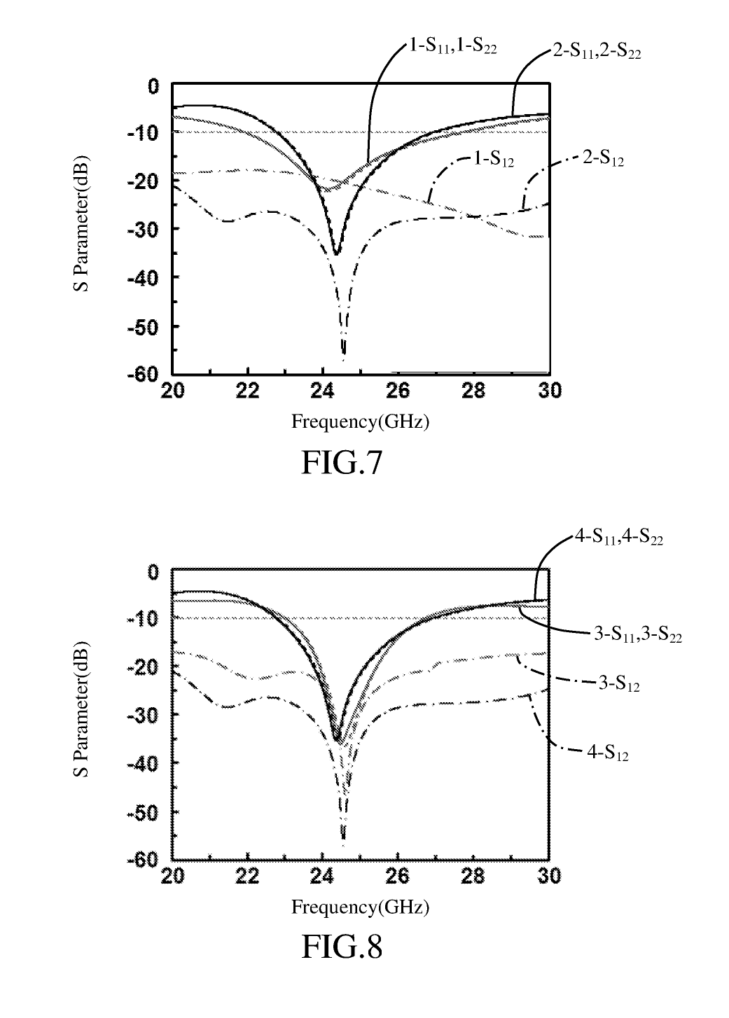

Please refer to FIG. 7 for a comparison between the fourth embodiment of the invention and an antenna system without any isolator. The plot shows the characteristic curves of the S parameter. The curves 1-S₁₁, 1-S₂₂, 1-S₁₂ represent the characteristic curves of the antenna system without any isolator. Two of the curves 1-S₁₁, 1-S₂₂ are almost identical. The other set of curves 2-S₁₁, 2-S₂₂, 2-S₁₂ represent the characteristic curves obtained from the antenna system in the fourth embodiment. Two of the curves 2-S₁₁, 2-S₂₂ are almost identical. The data of the invention and the antenna system without any isolator are measured and shown in the following table. It is seen the 2-S₁₂ curve is more concave and lower than the 1-S₁₂ curve, indicating that the isolation of the invention is improved over the prior art.

| | Bandwidth | Isolation \|S₁₂\| |
|---|---|---|
| | [S₁₁(S₂₂)/−10 dB] | [S₁₁(S₂₂)/−10 dB] |
| Antenna system of the | S₁₁ = 4.2 GHz | ≥27 dB |
| invention | S₂₂ = 4.2 GHz | |
| Antenna system | S₁₁ = 5.9 GHz | ≥18 dB |
| without any isolator | S₂₂ = 5.9 GHz | |

FIG. 8 shows a comparison between the third embodiment and the fourth embodiment of the invention, presented in terms of the S parameter characteristic curves. The characteristic curves 3-S₁₁, 3-S₂₂ and 3-S₁₂ are measured for the configuration of disposing a U-shaped first isolator 40 and a second isolator 40a between the two radiation antennas 20, 30 according to the third embodiment. The characteristic curves 3-S₁₁ and 3-S₂₂ are almost identical. The other set of characteristic curves 4-S₁₁, 4-S₂₂ and 4-S₁₂ are measured for the configuration of disposing two U-shaped first isolators 40 and two second isolators 40a between the two radiation antennas 20, 30 according to the fourth embodiment. The two characteristic curves 4-S₁₁ and 4-S₂₂ are almost identical. The antenna system data in these two embodiments are measured and given in the following table. It shows that when the number of isolators 40, 40a increases, the isolating effect also becomes better. By comparing the two curves 3-S₁₂ and 4-S₁₂, it is clear that the 4-S₁₂ curve is lower and more concave than the 3-S₁₂ curve. This proves that multi-level isolation has a better isolating effect.

| | Bandwidth | | | | |
|---|---|---|---|---|---|
| | [S₁₁(S₂₂)/ | Isolation \|S₁₂\| | | | |
| | −10 dB] | [S₁₁(S₂₂)/−10 dB] | | Gain | Beamwidth |
| Third | S₁₁ = 3.8 GHz | ≥21 | dB | 5.5 dBi | XZ = 87° |
| embodiment | S₂₂ = 3.8 GHz | (23~26.8 | GHz) | | YZ = 68° |
| Fourth | S₁₁ = 4.2 GHz | ≥27 | dB | 5.5 dBi | XZ = 93° |
| embodiment | S₂₂ = 4.2 GHz | (22.8~27 | GHz) | | YZ = 100° |

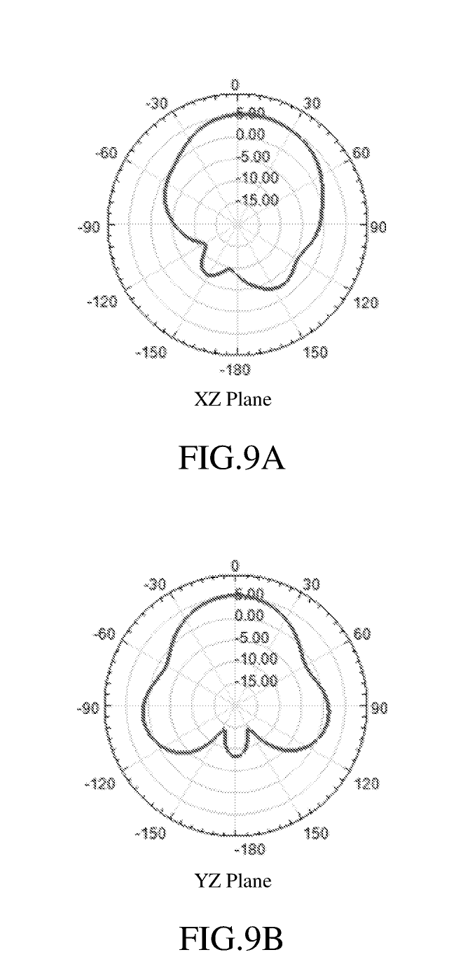

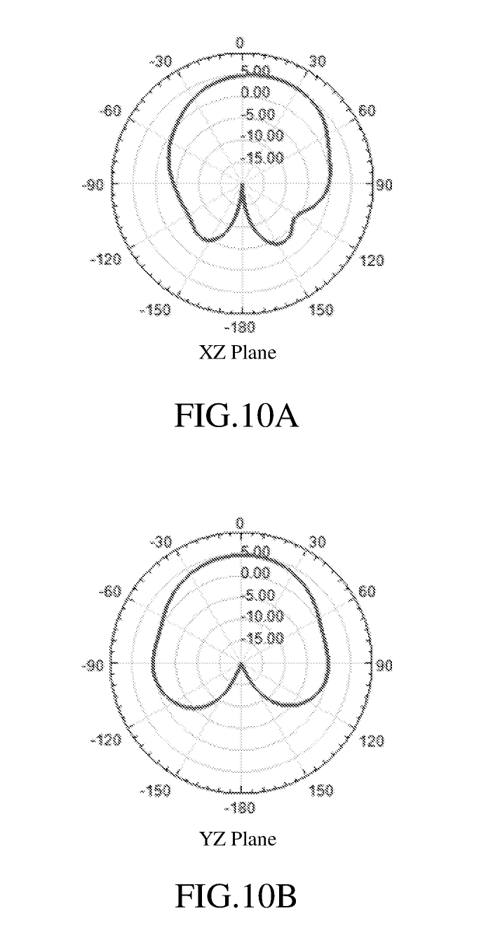

Measurements for the third embodiment in FIG. 4 give the radiation field patterns in the XZ and YZ planes as shown in FIGS. 9A and 9B, respectively. The antenna system has a good orientation along the Z axis. The radiation field pattern of the antenna is not affected even if the first and second isolators 40,40a are added. Likewise, when measuring the fourth embodiment in FIG. 6, one obtains the radiation field patterns in the XZ and YZ planes as shown in FIGS. 10A and 10B, respectively, with a good orientation along the Z axis.

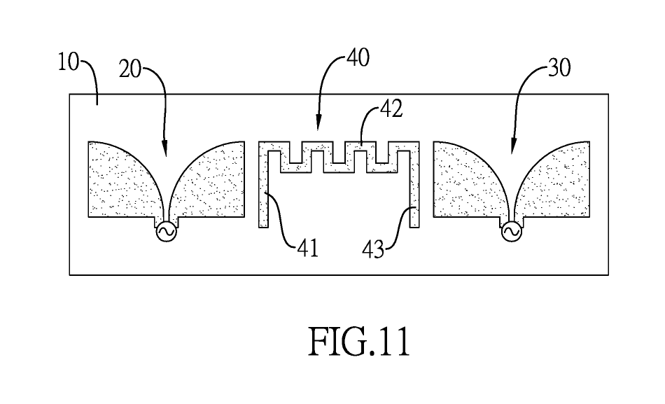

Please refer to FIG. 11 for a fifth embodiment of the invention. In this embodiment, the second metal strip 42 of the first isolator 40 is changed from a straight stripe to a continuous bent shape. This can effectively increase the length b of the second metal strip 42 within a limited space, thereby adjusting the overall length of the first isolator 40. Even if the space between the first radiation antenna 20 and the second radiation antenna 30 is limited, the resonance matching requirement is still satisfied. This is advantageous to antenna miniaturization.

The disclosed multi-antenna system has a wide range of applications. In addition to handheld mobile communication devices or wearable devices, it can also be applied to wireless positioning tags in the field of medication. For example, it can be used in a ridge clip positioning tag for minimally invasive surgery of the spine. Using the ISM-band 24 GHz operating frequency, the precision in positioning can achieve the mm level.

In summary, the invention provides at least one isolator between two adjacent radiation antennas. The isolator is adjacent to the non-radiation coupling edge of each radiating element to achieve the effect of filter isolation, improving the isolation characteristics of the antenna system. As the isolator corresponds to the non-radiation coupling edge, there is no need to keep the distance between the isolator and the radiation antenna to a specific value. By adjusting the lengths a, b, and c of the isolator, one can obtain the required resonance frequency.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A multi-antenna system that utilizes non-radiation coupling edges to achieve isolation, comprising a substrate that is provided with:
a first radiation antenna having a first resonance radiating portion, a first feeding portion, and a first non-radiation coupling edge, with the first feeding portion used to feed signals to the first radiation antenna;
a second radiation antenna having a second resonance radiating portion, a second feeding portion, and a second non-radiation coupling edge, with the second feeding portion used to feed signals to the first radiation antenna, wherein the second radiation antenna and the first radiation antenna are operated at nearby frequencies; and
at least one first isolator disposed between the first radiation antenna and the second radiation antenna and extending from the first non-radiation coupling edge toward the second non-radiation coupling edge.

2. The multi-antenna system as claimed in claim 1, wherein the at least one first isolator includes a plurality of first isolators separated from each other by a distance.

3. The multi-antenna system as claimed in claim 1, wherein the first radiation antenna has a third non-radiation coupling edge and the second radiation antenna has a fourth non-radiation coupling edge, the substrate is a flexible substrate and curled into a cylindrical shape, and at least one second isolator is disposed between the third non-radiation coupling edge and the fourth non-radiation coupling edge.

4. The multi-antenna system as claimed in claim 3, wherein each of the first resonance radiation portion and the second resonance radiation portion has:
two sector radiating elements disposed in a symmetric way, each of the sector radiating elements has an arc edge, a bottom edge, and a side edge, with the two arc edges opposite to each other and kept at a distance to form a conic groove;
wherein the side edge of one of the sector radiating elements of the first radiation antenna functions as the first non-radiation coupling edge, and the side edge of the other sector radiating element of the first radiation antenna functions as the third non-radiation coupling edge; and
the side edge of one of the sector radiating elements of the second radiation antenna functions as the second non-radiation coupling edge, and the side edge of the other sector radiating element of the second radiation antenna functions as the fourth non-radiation coupling edge.

5. The multi-antenna system as claimed in claim 3, wherein the at least one first isolator includes a plurality of first isolators separated from each other by a distance; and the at least one second isolator comprises a plurality of second isolators separated from each other by a distance.

6. The multi-antenna system as claimed in claim 5, wherein each of the first isolators and each of the second isolators includes a first metal strip, a second metal strip, and a third metal strip, with the first metal strip, the second metal strip and the third metal strip forming an inverted-U shape; and
the first metal strip and the third metal strip respectively extend in a direction parallel to the first non-radiation coupling edge and the second non-radiation coupling edge.

7. The multi-antenna system as claimed in claim 6, wherein the second metal strip is shaped as a straight stripe.

8. The multi-antenna system as claimed in claim 6, wherein the second metal strip has a continuous bent shape.

9. The multi-antenna system as claimed in claim 7, wherein the first radiation antenna and the second radiation antenna are both Vivaldi antennas.

10. The multi-antenna system as claimed in claim 8, wherein the first radiation antenna and the second radiation antenna are both Vivaldi antennas.
